(19) United States
(12) Patent Application Publication
(10) Pub. No.: US 2009/0322258 A1
(43) Pub. Date: Dec. 31, 2009

(54) Carbon nanotube electron source

(76) Inventor: Cattien V. Nguyen, San Jose, CA (US)

Correspondence Address: WAGNER, MURABITO & HAO LLP;Third Floor, Two North Market Street, San Jose, CA, 95113, US

(21) Appl. No.: 11/729,124

(22) Filed: Mar. 27, 2007

(51) Int. Cl. H01J 1/02; H01J 9/02

(52) U.S. Cl. 315/326; 445/51; 313/310; 977/742; 977/842

(57) ABSTRACT

A method of producing an electron source, a carbon nanotube (CNT) electron source, and a method of field emission using an electron source are disclosed. Embodiments provide convenient and effective mechanisms for improving thermal and mechanical performance of CNT electron sources, in one example, by heating a polymer-based matrix (e.g., PDMS) beyond its curing point until the polymer decomposes to form a cross linked and rigid matrix comprising silicon dioxide (SiO₂). Additionally, embodiments provide convenient, effective and cost-efficient mechanisms for producing large-scale electron sources with controlled and nearly uniform CNT densities by spin coating a CNT/PDMS solution onto a substrate comprising an electrode, where an electric field is used to align the CNTs while the matrix is heated to convert the PDMS-based matrix to an SiO₂-based matrix to secure the CNTs with respect to one another and with respect to the substrate.

### BACKGROUND OF THE INVENTION

A carbon nanotube (CNT) is one or more sheets of graphite rolled into a tube with a diameter on the order of a nanometer. Single-walled carbon nanotubes (SWNTS) consist of a single sheet of graphite with a thickness of roughly one atom, whereas multi-walled carbon nanotubes (MWNTs) consist of multiple sheets of graphite rolled into concentric tubes. In general, CNTs are an attractive option for electron emission given their robust physical, chemical and electrical properties. And in particular, CNTs perform well as cold field emitters due to their high aspect ratios providing low turn-on fields.

CNTs are generally grown on small pads of metal catalysis (e.g., nickel, iron or cobalt) using thermal chemical vapor deposition. A relatively small number of CNTs are grown in a column on each pad. To provide portability and enable manipulation of the pads, the CNTs are flooded with a polydimethylsiloxane (PDMS) matrix, which is then cured at low temperature. The cured polymer matrix also provides support for the CNTs during operation. After curing, the composite film containing CNTs and a PDMS matrix may be transported and used in such applications as flexible electronics, switches, sensors and other small-scale applications.

Although such composite films containing grown CNTs may suffice for small-scale applications, they perform poorly and are otherwise inadequate for higher-current, larger-scale applications. For example, applications requiring higher currents produce more heat and higher temperatures from the CNTs, which can lead to degradation of the polymer matrix and outgassing from the polymer matrix. Field emission applications often require precise and consistent alignment of the CNTs. However, degradation of the polymer matrix undermines the support provided to the CNTs, thereby causing misalignment and enabling movement of the CNTs. Additionally, outgassing can interfere with field emission and operation of components utilizing the CNTs for such field emission. The problems produced by outgassing are often exacerbated by the presence of a vacuum environment required by many field emission applications.

In addition to the poor thermal performance, conventional CNT arrays generally exhibit poor spacing of CNT emitter tips. Poor CNT spacing produces varying current densities over the array, which therefore requires more voltage to produce the same field emission current when compared to an array with a constant density. Areas of higher CNT density require more voltage to turn on the emitters due to field screening effects produced by surrounding emitters. Additionally, more voltage is required to increase the field emission current of areas with lower CNT density to match that of areas of higher CNT density since fewer emitters are present to emit electrons in the areas of lower CNT density. Thus, conventional CNT arrays consume excess power and operate at high temperatures, thereby increasing the likelihood of CNT movement and outgassing problems discussed above. Consequently, conventional CNT arrays are limited to applications requiring relatively low field emission current.

Large CNT patches with acceptable CNT density variations are very expensive to grow. As such, conventional CNT arrays are often grown on small substrate pads, thereby forcing applications requiring larger CNT arrays to use many small CNT arrays placed side-by-side. Thus, CNT density variations exist not only within each CNT array, but also between the multiple CNT arrays used together in the larger application. Consequently, conventional CNT arrays are limited to applications requiring small CNT array area.

Additionally, CNT arrays utilizing a PDMS matrix are unable to maintain the CNT alignment required by more demanding or precise applications. While the flexibility and pliability of PDMS are beneficial in applications such as flexible electronics, these qualities are conducive to misalignment, movement and vibration of CNTs. Consequently, conventional CNT arrays are limited to the less-demanding or less-precise applications.

As an alternative to growing CNT arrays on substrates, a polymer paste containing previously-formed CNTs may be spread on a substrate to produce random-orientation field emitters. Given that the CNTs are not aligned, the field emission of such conventional CNT emitters is very low regardless of the magnitude of the applied electric field. Additionally, such conventional solutions also provide very poor current density. Further, such conventional CNT emitters suffer the same CNT movement and outgassing problems as the conventional grown CNT emitters discussed above. Thus, conventional random-orientation field emitters have very few practical applications.

### SUMMARY OF THE INVENTION

Accordingly, a need exists for a carbon nanotube (CNT) electron source with enhanced thermal performance. A need also exists for a CNT electron source which more rigidly supports the CNTs, thereby decreasing misalignment, movement and vibration of the CNTs. Additionally, a need exists for a CNT electron source that can be produced on a larger scale with more uniform tip spacing and reduced cost. Embodiments of the present invention provide novel solutions to these needs and others as described below.

Embodiments of the present invention are directed to a method of producing an electron source, a CNT electron source, and a method of providing field emission current using an electron source. More specifically, embodiments provide convenient and effective mechanisms for improving thermal and mechanical performance of CNT electron sources, in one example, by heating a polymer-based matrix (e.g., PDMS) beyond its curing point until the polymer decomposes to form a cross linked and rigid matrix comprising silicon dioxide (SiO₂). Additionally, embodiments provide convenient, effective and cost-efficient mechanisms for producing large-scale electron sources with controlled and nearly uniform CNT densities by spin coating a CNT/PDMS solution onto a substrate comprising an electrode, where an electric field is used to align the CNTs while the matrix is heated to convert the PDMS-based matrix to an SiO₂-based matrix to secure the CNTs with respect to one another and with respect to the substrate.

In one embodiment, a method of producing an electron source includes applying a mixture to a substrate including an electrode, where the mixture includes a polymer-based solution and a plurality of carbon nanotubes. An electric field is applied to the plurality of carbon nanotubes to align the plurality of carbon nanotubes to produce a plurality of aligned carbon nanotubes. The plurality of aligned carbon nanotubes is secured by transforming the polymer-based solution into a solidified matrix while maintaining the electric field. The method may further include preparing the mixture, where the preparing further includes adding a conductive dopant to the mixture. Additionally, the spacing between the plurality of aligned carbon nanotubes after application of the electric field may be controlled because it may depend upon at least one of a concentration of carbon nanotubes in the mixture and a thickness of the mixture applied to the substrate.

In another embodiment, a carbon nanotube electron source includes a substrate including an electrode. The electron source also includes a plurality of aligned carbon nanotubes, where the plurality of aligned carbon nanotubes are distinct from the electrode, and where the plurality of aligned carbon nanotubes are operable to emit electrons in response to an electric field applied to the electrode. A matrix is disposed between the plurality of aligned carbon nanotubes for securing the plurality of aligned carbon nanotubes with respect to one another and with respect to the substrate. The matrix may include silicon dioxide (SiO₂). Also, the matrix may include a conductive dopant. Additionally, at least one of the plurality of aligned carbon nanotubes may not be in physical contact with the electrode, where the conductive dopant provides conductivity between the electrode and the at least one carbon nanotubes not in physical contact with the electrode.

In yet another embodiment, a method of providing field emission current using an electron source includes applying an electric field to the electron source, where the electron source includes a substrate comprising an electrode. The electron source also includes a plurality of aligned carbon nanotubes, where the plurality of aligned carbon nanotubes are distinct from the electrode, and where the plurality of aligned carbon nanotubes are operable to emit electrons in response to a field applied to the electrode. The electron source further includes a matrix disposed between the plurality of aligned carbon nanotubes for securing the plurality of aligned carbon nanotubes with respect to one another and with respect to the substrate. After applying the electric filed, electrons are emitted from the plurality of aligned carbon nanotubes to provide the field emission current, where at least one of the plurality of aligned carbon nanotubes is in physical contact with the electrode. The matrix may include silicon dioxide (SiO₂). Also, the matrix may include a conductive dopant. Additionally, each of the plurality of aligned carbon nanotubes may be substantially equidistant from adjacent carbon nanotubes, where a current density across the plurality of aligned carbon nanotubes is substantially uniform. The method may also include using the field emission current to perform at least one of image display, electron microscopy, field emission lighting, x-ray source, space propulsion, traveling wave tube amplifiers, air remediation, water remediation and cold field emission.

### BRIEF DESCRIPTION OF THE DRAWINGS

The present invention is illustrated by way of example, and not by way of limitation, in the figures of the accompanying drawings and in which like reference numerals refer to similar elements.

FIG. 1 shows an exemplary process for producing an electron source in accordance with one embodiment of the present invention.

FIG. 2 shows a diagram of exemplary production stages of an electron source in accordance with one embodiment of the present invention.

FIG. 3 shows an exemplary system for producing an electron source in accordance with one embodiment of the present invention.

FIG. 4 shows an exemplary process for providing field emission current using an electron source in accordance with one embodiment of the present invention.

FIG. 5 shows exemplary field emission from an exemplary carbon nanotube electron source in accordance with one embodiment of the present invention.

### DETAILED DESCRIPTION OF THE INVENTION

Reference will now be made in detail to embodiments of the present invention, examples of which are illustrated in the accompanying drawings. While the present invention will be discussed in conjunction with the following embodiments, it will be understood that they are not intended to limit the present invention to these embodiments alone. On the contrary, the present invention is intended to cover alternatives, modifications, and equivalents which may be included with the spirit and scope of the present invention as defined by the appended claims. Furthermore, in the following detailed description of the present invention, numerous specific details are set forth in order to provide a thorough understanding of the present invention. However, embodiments of the present invention may be practiced without these specific details. In other instances, well-known methods, procedures, components, and circuits have not been described in detail so as not to unnecessarily obscure aspects of the present invention.

### Embodiments of the Invention

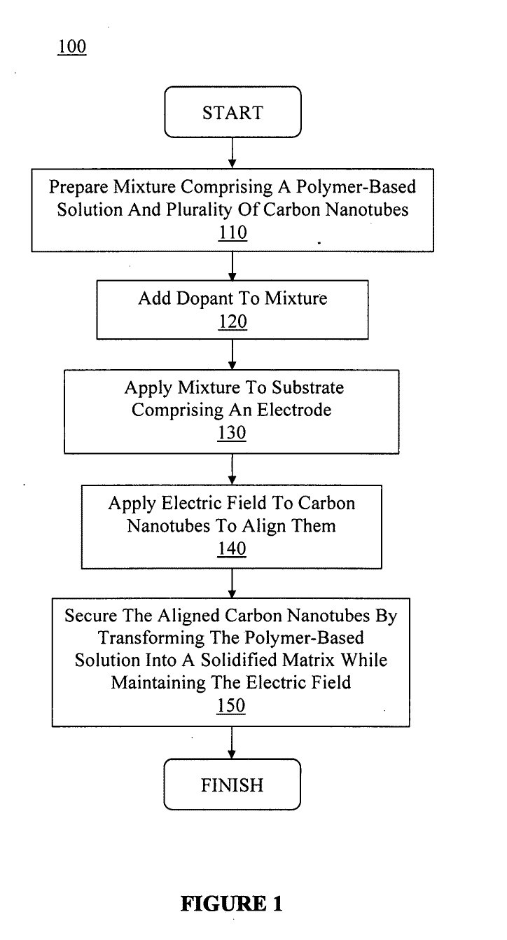

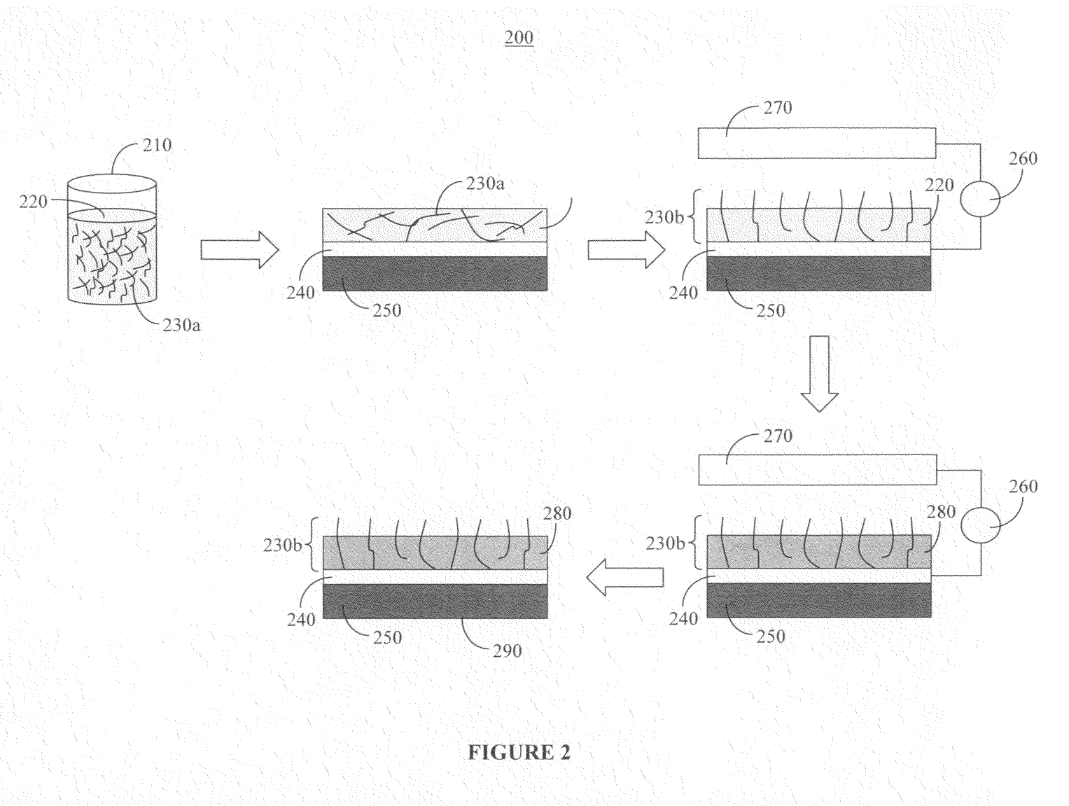

FIG. 1 shows exemplary process 100 for producing an electron source in accordance with one embodiment of the present invention. FIG. 2 shows diagram 200 of exemplary production stages of an electron source in accordance with one embodiment of the present invention. In one embodiment, the production stages depicted in FIG. 2 may correspond with one or more steps of process 100. As such, FIG. 2 will be described in conjunction with FIG. 1.

As shown in FIG. 1, step 110 involves preparing a mixture comprising a polymer-based solution and a plurality of carbon nanotubes (CNTs). For example, as shown in FIG. 2, CNTs 230a may be mixed with polymer-based solution 220 to form mixture 210. Additionally, solvents and/or other additives (e.g., dopants as discussed below, chemical additives, etc.) may be added to the mixture (e.g., 210). In one embodiment, polymer-based solution 220 may comprise polydimethylsiloxane (PDMS) or other polymer comprising silicone (e.g., an organosilicone) that may be transformed (e.g., by heating beyond the curing temperature to cause degradation or decomposition of the polymer) into silicon dioxide (SiO₂).

Alternatively, solution 220 may comprise a viscous, polymer-based solution which may be cured to form a thermosetting polymer matrix or otherwise transformed into another solidified material matrix, where the resulting matrix possesses sufficient physical and/or electrical properties required for stable, controlled electron field emission. Curing may be characterized by cross-linking of polymer chains, and may comprise thermal polymerization (e.g., inducing cross-linking by heating the solution), chemical polymerization (e.g., inducing cross-linking by introducing a given chemical to the solution), photochemical polymerization (e.g., inducing cross-linking by exposing the solution to electromagnetic radiation such as ultraviolet light), etc. Alternatively, transformation may be induced, in one embodiment, by heating the solution (e.g., 220) beyond the curing temperature to cause degradation or decomposition of the polymer (e.g., similar to a PDMS or other organosilicone solution discussed above). In other embodiments, transformation may be facilitated by chemical and/or photochemical reactions.

In one embodiment, a solution (e.g., 220) used to produce a matrix (e.g., 280 of FIG. 2) other than SiO₂ may possess a curing temperature of less than approximately 450° C. Additionally, the resulting matrix (e.g., 280) can have high temperature stability to withstand the heat produced by the CNTs during use. In one embodiment, the matrix (e.g., 280) can withstand temperatures of at least 300° C. without significantly effecting field emission properties of the completed electron source (e.g., 290 of FIG. 2). Additionally, adequate heat dissipation from the CNTs during operation (e.g., providing field emission current) can be provided by the resulting matrix (e.g., having sufficient thermal conductivity to sustain operation of the CNTs). The matrix should also have adequate physical properties (e.g., stiffness, etc.) to support the CNTs during operation (e.g., to reduce movement and/or vibration of the CNTs), where the degree of polymerization (or molecular weight) of the matrix may range from a few thousands to infinity.

It is appreciated that the concentration of CNTs (e.g., 230a) in the mixture (e.g., 210) may be used to control the density (e.g., distance between the CNT tips) of the aligned CNTs (e.g., 230b of FIG. 2) in the completed electron source (e.g., 290), thereby providing a convenient and effective means for adjusting the current density of the completed electron source (e.g., 290). In one embodiment, the concentration of CNTs (e.g., 230a) in the solution (e.g., 220) may exceed approximately 10 percent of the mass of the mixture (e.g., 210). Additionally, the average length of the aligned CNTs (e.g., 230b) in the completed electron source (e.g., 290) may relate to the lengths of the CNTs (e.g., 230a) in the mixture (e.g., 210). As such, the average length of the CNTs (e.g., 230b) in the completed electron source (e.g., 290) may be varied to control emission properties of the CNTs by simply varying the length of CNTs (e.g., 230a) added to the mixture (e.g., 210).

As shown in FIG. 1, step 120 involves adding a dopant to the mixture (e.g., 210) of the polymer-based solution (e.g., 220) and the CNTs (e.g., 230a). The dopant may alter electrical and/or physical properties of the resulting matrix. For example, the dopant may provide or improve conduction of electricity through the matrix. Alternatively, the dopant may improve physical properties of the matrix such as strength, stiffness, resistance to deformation/creep, molecular weight, etc., thereby decreasing movement and/or vibration of the CNTs during use.

In one embodiment, the dopant may be added simultaneously with the CNTs (e.g., 230a) to the polymer-based solution (e.g., 220) to form the mixture (e.g., 210). Alternatively, the dopant may be added to the solution (e.g., 220) before and/or after the CNTs (e.g., 230a) are added.

As shown in FIG. 1, step 130 involves applying the mixture (e.g., 210) to a substrate (e.g., 250) comprising an electrode (e.g., 240). The mixture may be disposed over a large surface area in a thin film, where at least a portion of thin film is in physical contact with the electrode (e.g., 240). The thickness of the mixture (e.g., 210) applied to the substrate (e.g., 250) may be varied, in one embodiment, by altering the viscosity of the mixture (e.g., by adding solvents or other additives). In one embodiment, the thickness of the mixture (e.g., 210) applied to the substrate (e.g., 250) may be used to control the density of the CNTs (e.g., distance between the tips of the CNTs) in the completed electron source (e.g., 290 of FIG. 2), thereby providing a convenient and effective means for adjusting the current density of the completed electron source (e.g., 290).

In one embodiment, a spin coater may be used to apply the mixture (e.g., 210) to the substrate (e.g., 250). The spin coater may produce a uniform disposition of the mixture (e.g., 210) over a large area, thereby increasing the uniformity of the CNT density and current density of the completed electron source (e.g., 290). Further, the thickness of the mixture (e.g., 210) applied to the substrate may be varied by changing the speed of the spin coater in one implementation. As such, embodiments provide even more convenient means for controlling the density of the CNTs and the resulting current density of the completed electron source (e.g., 290). And in other embodiments, applicators other than a spin coater may be used to apply the mixture (e.g., 210) to the substrate (e.g., 250).

Although FIG. 2 depicts electrode 240 as covering all of substrate 250, it should be appreciated that electrode 240 may cover only a portion of substrate 250 in other embodiments. Additionally, although electrode 240 is depicted in FIG. 2 as a single portion, it should be appreciated that electrode 240 may comprise multiple portions in other embodiments, where the individual portions may or may not be coupled to one another.

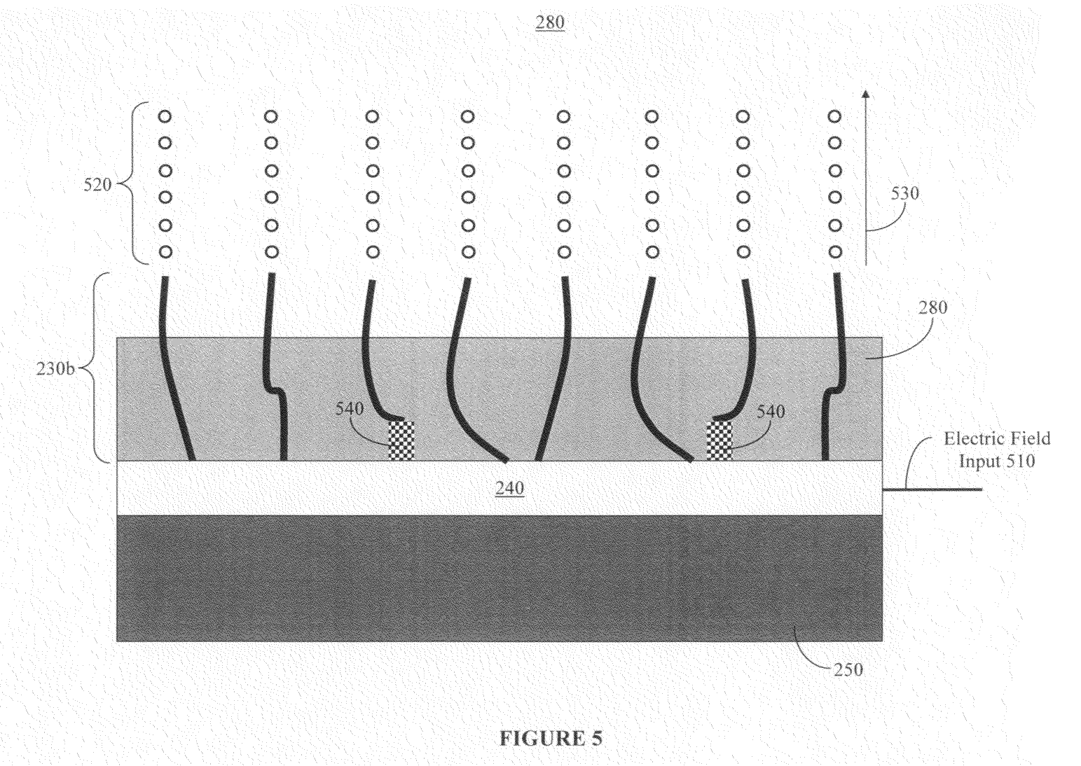

As shown in FIG. 1, step 140 involves applying an electric field to the CNTs (e.g., 230a) to align them. As shown in FIG. 2, electric field 270 is applied between electrode 240 and electrode 270 to produce aligned CNTs 230b. In one embodiment, an electric field of approximately 5 V/μm may be applied between electrodes 240 and 270, where the μm unit refers to the distance between electrode 270 and the tips of aligned CNTs 230b (e.g., an average position of the emitter tips). When aligned, at least some of the distinct CNTs (e.g., 230b) may be brought into physical contact with the electrode (e.g., 240) to enable electron field emission when a voltage or electric field is applied to the electrode (e.g., 240). For those CNTs not in physical contact with the electrode, a conductive dopant within the mixture (e.g., 210) may provide continuity between the electrode (e.g., 240) and the CNTs not in physical contact with the electrode (e.g., 240), thereby enabling electron field emission from nearly all aligned CNTs (e.g., as shown in FIG. 5).

Electric field 260 may align CNTs 230b in a substantially parallel arrangement with respect to one another according to the direction of the applied field. In another embodiment, the CNTs (e.g., 230b) may be aligned in a substantially perpendicular arrangement to electrode 240 and/or substrate 250. Additionally, electric field 260 may provide nearly equidistant spacing of the CNTs (e.g., 230b), thereby producing a nearly uniform CNT density across the completed electron source (e.g., 290). The CNT density may be controlled by adjusting the concentration of CNTs (e.g., 230a) in the mixture (e.g., 210) and/or by varying the thickness of the mixture (e.g., 210) applied to the substrate (e.g., 250) as discussed above.

As shown in FIG. 1, step 150 involves securing the aligned CNTs (e.g., 230b) by transforming the polymer-based solution (e.g., 220) into a solidified matrix while maintaining the electric field (e.g., 260). Where solution 220 comprises PDMS and/or an organosilicone, the solution (e.g., 220) may be transformed to an SiO₂ matrix (e.g., 280) while maintaining electric field 260, thereby utilizing the strength and stiffness of the SiO₂ (e.g., due to its highly cross-linked structure) to secure the aligned CNTs (e.g., 230b) in the arrangement created by electric field 260. The PDMS and/or organosilicone may be transformed to SiO₂ by heating it beyond its curing temperature until it begins to decompose or degrade, which may be characterized by outgassing, burning, or charring. In one embodiment, a temperature in the approximate range of 380° C. to 460° C. may be applied to the PDMS and/or organosilicone solution (e.g., 220) to produce the SiO₂ matrix (e.g., 280).

Polymer-based solutions producing matrix materials other than SiO₂ may also be used to secure the aligned CNTs (e.g., 230b) before releasing the electric field (e.g., 260). As discussed above, the matrix (e.g., 280) may comprise a thermosetting polymer which may be cured (e.g., by heating, chemical curing, photochemical curing, etc.) to secure the CNTs. Alternatively, the matrix (e.g., 280) may comprise a material produced by transforming a polymer-based solution or thermosetting polymer. The transformation may be induced by heating the material beyond its curing temperature, adding a chemical to the material to induce a chemical transformation, applying a specific type of light (e.g., ultraviolet light) to the material to cause photochemical transformation, etc. Accordingly, the strength and/or stiffness of the resulting matrix may secure the CNTs (e.g., 230b) in the arrangement produced by application of the electric field (e.g., 260) before the curing and/or transformation. Additionally, the resulting matrix may provide heat dissipation for the CNTs (e.g., 230), thereby enabling the CNTs to handle higher currents during operation (e.g., field emission).

As shown in FIG. 2, after the aligned CNTs (e.g., 230b) are secured by the solidified matrix (e.g., 280), the electric field (e.g., 260) may be removed from the completed electron source (e.g., 290). As such, embodiments provide an electron source (e.g., 290) with a nearly uniform CNT density capable of stable, high current density electron field emission using a relatively small electric field (e.g., applied to electrode 240 during use as opposed to during alignment). The current density may be conveniently varied by simply varying the concentration of CNTs (e.g., 230a) in the mixture (e.g., 210) and/or varying the thickness of the mixture (e.g., 210) applied to the substrate (e.g., 250). Additionally, the size of the electron source produced may be easily scaled (e.g., limited only by available substrate sizes and capabilities of the spin coater). Further, the above benefits are provided at a relatively low cost given the use of distinct CNTs (e.g., 230a/230b) aligned by an applied electric field (e.g., 260).

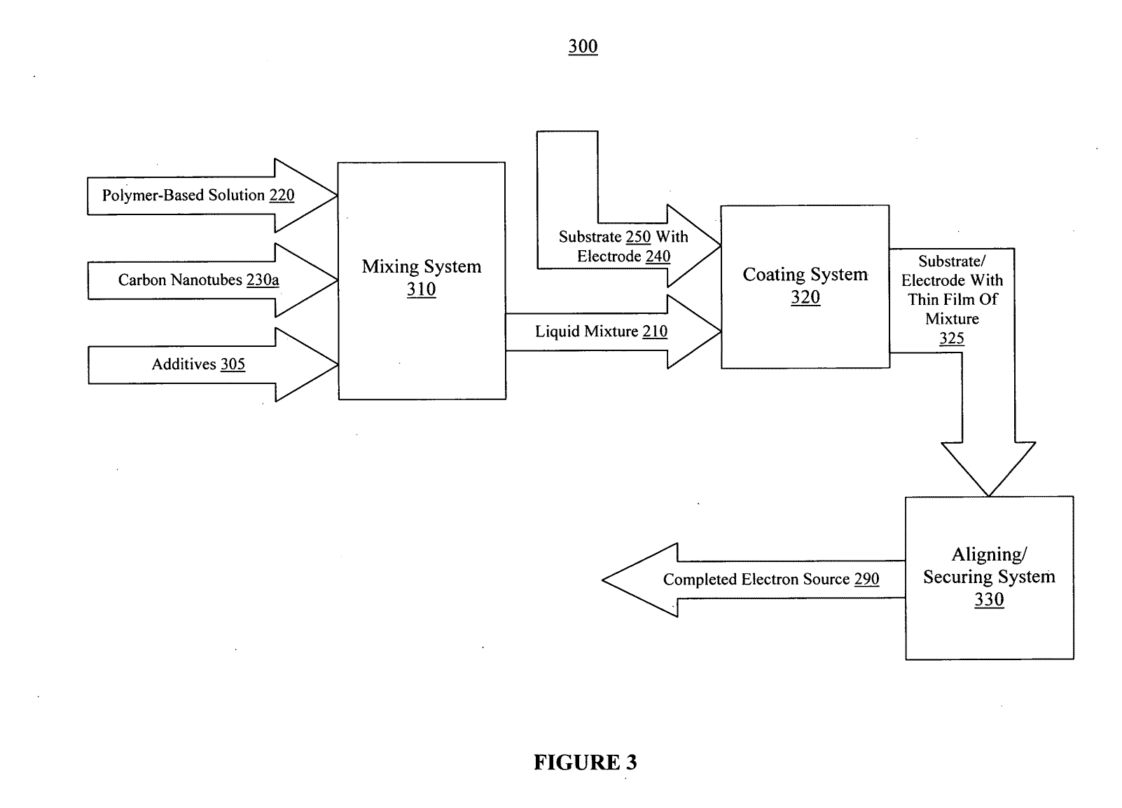

FIG. 3 shows exemplary system 300 for producing an electron source in accordance with one embodiment of the present invention. As shown in FIG. 3, mixing system 310 receives the polymer-based solution 220 and CNTs 230a. Additional additives 305 may optionally be added in one embodiment, where the additives may comprise solvents (e.g., to adjust the viscosity of the mixture), dopants (e.g., to adjust electrical and/or physical properties of the mixture), other additives (e.g., to adjust chemical properties of the mixture), or any combination thereof.

Mixing system 310 may utilize mechanical agitation (e.g., sonication, etc.), stirring, or other forms of mixing to prepare the mixture (e.g., 210). Alternatively, mixing system 310 may not actively mix the constituents of the mixture, but instead only store them before application by coating system 320. As such, the mixture may be mixed during transition to the coating system, or instead, by coating system 320 (e.g., during application).

As shown in FIG. 3, coating system 320 receives substrate 250 with electrode 240 as well as liquid mixture 210 output by mixing system 310. Coating system 320 may apply a relatively thin film of mixture 210 to substrate 250, where at least a portion of the thin film of mixture 210 is in physical contact with electrode 240. The film may be substantially uniform across the surface area of the substrate (e.g., 250) receiving the film in one embodiment. And as discussed above, the mixture (e.g., 210) may be applied to the substrate (e.g., 250) by a spin coater or other application system capable of uniformly disposing a relatively thin film over a large surface area. Where a spin coater is used, the speed of the spin coater may be controlled to adjust the thickness of the mixture (e.g., 210) applied to the substrate (e.g., 250).

Aligning/securing system 330 receives the substrate/electrode with the thin film of the mixture 325 output from the coating system 320. System 330 may align the CNTs (e.g., 230a) in the mixture (e.g., 210) using an electric field (e.g., 260) to produce a plurality of aligned CNTs (e.g., 230b) as shown in FIG. 2. While maintaining the electric field (e.g., 260), the mixture (e.g., 210) may be cured and/or transformed to produce a solidified matrix for securing the arrangement of the aligned CNTs (e.g., 230b). After the CNTs have been secured in place, the electric field (e.g., 260) may be released and the completed electron source (e.g., 290) may be output from aligning/securing system 330.

Although FIG. 3 depicts systems 310-330 as separate systems, it should be appreciated that one or more of systems 310-330 may be combined in other embodiments. Additionally, it should be appreciated that one or more of systems 310-330 may be separated into multiple subsystems in other embodiments.

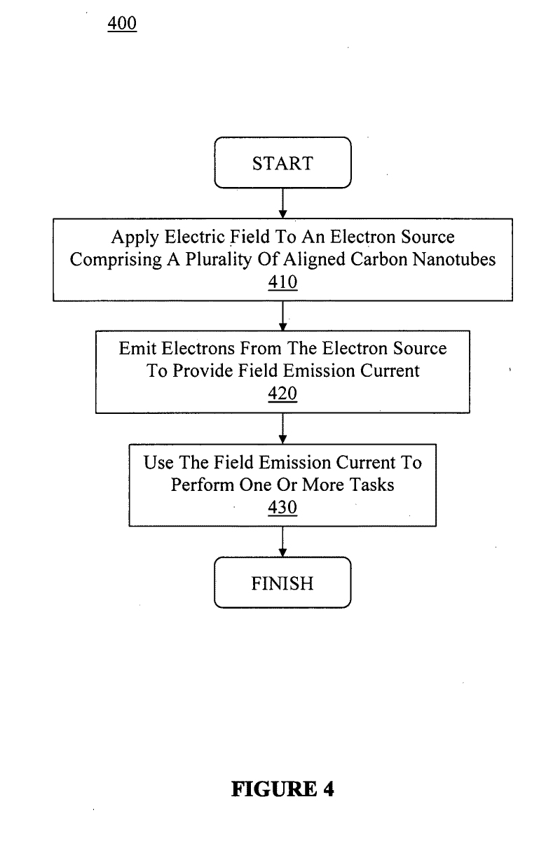

FIG. 4 shows exemplary process 400 for providing field emission current using an electron source in accordance with one embodiment of the present invention. FIG. 5 shows exemplary field emission from exemplary carbon nanotube electron source 290 in accordance with one embodiment of the present invention. In one embodiment, electron source 290 as depicted in FIG. 5 (and also depicted in FIG. 2) may be used for field emission in accordance with process 400. As such, FIG. 5 will be described in conjunction with FIG. 4.

As shown in FIG. 4, step 410 involves applying an electric field to an electron source comprising a plurality of aligned nanotubes. In one embodiment, the electric field may be applied to electric field input 510 of electron source 290 shown in FIG. 5, where electron source 290 comprises aligned CNTs 230b secured in matrix 280. The CNTs (e.g., 230b) may be aligned in a substantially parallel arrangement with respect to one another. In another embodiment, the CNTs (e.g., 230b) may be aligned in a substantially perpendicular arrangement to electrode 240 and/or substrate 250. Additionally, the emitter tips of the CNTs (e.g., 230b) may be uniformly spaced with respect to one another.

After the electric field is applied to the electron source (e.g., 290), the electron source may emit electrons to provide field emission current in step 420. As shown in FIG. 5, electrode 240 may be biased by the electric field applied to input 510, thereby causing CNTs 230b to emit electrons 520. The electrons (e.g., 520) may be emitted by the CNTs (e.g., 230b) away from electron source 290 (e.g., in the direction indicated by arrow 530).

Conduction between electrode 240 and the aligned CNTs (e.g., 230b) may be provided by physical contact between the electrode and the CNTs and/or a conductive path produced by a conductive dopant (e.g., added to mixture 210) present in matrix 280. In one embodiment, conductive paths 540 may enable aligned CNTs not in physical contact with the electrode (e.g., 240) to receive and emit electrons. Additionally, it should be appreciated that the conductive dopant may be present in other areas of matrix 280 in addition to or in place of conductive paths 540. Accordingly, in one embodiment, the conductive dopant may also enhance the conduction between electrode 240 and CNTs in physical contact with electrode 240.

Given the uniform spacing of CNTs 230b and the stiffness of matrix 280, electron source 290 may provide uniform, high-current density with a relatively small electric field applied to input 510. Additionally, the current density may be configured conveniently and with little added cost (e.g., by varying the concentration of CNTs in mixture 210 and/or the thickness of mixture 210 applied to substrate 250), thereby enabling electron sources to be produced with such uniform current density over a range of current densities (e.g., to suit a variety of applications). Further, electron source 290 may be capable of handling high currents for increased field emission given that CNTs 230b are secured in a matrix (e.g., comprising SiO2) with thermal properties (e.g., high temperature stability, thermal conductivity, etc.) sufficient to support such high-current field emission.

As shown in FIG. 4, step 430 involves using the field emission current to perform one or more tasks. In one embodiment, electron source 290 may be used in large-scale applications such as flat-panel displays. Alternatively, field emission current may be used in applications such as electron microscopy, field emission lighting, x-ray source, space propulsion, traveling wave tube amplifiers, air remediation, water remediation or cold field emission.

In the foregoing specification, embodiments of the invention have been described with reference to numerous specific details that may vary from implementation to implementation. Thus, the sole and exclusive indicator of what is, and is intended by the applicant to be, the invention is the set of claims that issue from this application, in the specific form in which such claims issue, including any subsequent correction. Hence, no limitation, element, property, feature, advantage, or attribute that is not expressly recited in a claim should limit the scope of such claim in any way. Accordingly, the specification and drawings are to be regarded in an illustrative rather than a restrictive sense.

What is claimed is:

1. A method of producing an electron source, said method comprising:
applying a mixture to a substrate comprising an electrode, wherein said mixture comprises a polymer-based solution and a plurality of carbon nanotubes;
applying an electric field to said plurality of carbon nanotubes to align said plurality of carbon nanotubes to produce a plurality of aligned carbon nanotubes; and
securing said plurality of aligned carbon nanotubes by transforming said polymer-based solution into a solidified matrix while maintaining said electric field.

2. The method of claim 1, wherein said transforming is performed by at least one of applying heat, chemical curing, and photochemical curing.

3. The method of claim 1, wherein said polymer-based solution comprises polydimethylsiloxane (PDMS).

4. The method of claim 1, wherein said plurality of carbon nanotubes are secured by cross-linking of said matrix produced during said transforming.

5. The method of claim 1, wherein said matrix comprises silicon dioxide (SiO₂) generated by decomposing said polymer-based solution.

6. The method of claim 1, wherein said transforming also secures said plurality of aligned carbon nanotubes to said substrate.

7. The method of claim 1 further comprising:
preparing said mixture, wherein said preparing further comprises adding a conductive dopant to said mixture.

8. The method of claim 1, wherein said applying said mixture to said substrate comprises using a spin coater.

9. The method of claim 8, further comprising controlling a thickness of said mixture applied to said substrate by at least one of controlling a viscosity of said mixture and controlling a speed of said spin coater.

10. The method of claim 1, further comprising controlling a spacing between said plurality of aligned carbon nanotubes after application of said electric field by at least one of controlling a concentration of carbon nanotubes in said mixture and controlling a thickness of said mixture applied to said substrate.

11. The method of claim 1, wherein an average length of said plurality of aligned carbon nanotubes is related to the lengths of carbon nanotubes in said mixture.

12. A carbon nanotube electron source comprising:
a substrate comprising an electrode;
a plurality of aligned carbon nanotubes, wherein said plurality of aligned carbon nanotubes are distinct from said electrode, and wherein said plurality of aligned carbon nanotubes are operable to emit electrons in response to an electric field applied to said electrode; and
a matrix disposed between said plurality of aligned carbon nanotubes for securing said plurality of aligned carbon nanotubes with respect to one another and with respect to said substrate.

13. The electron source of claim 12, wherein said plurality of aligned carbon nanotubes are aligned substantially perpendicular with respect to said substrate.

14. The electron source of claim 12, wherein said matrix comprises a cross-linked thermoset polymer.

15. The electron source of claim 12, wherein said matrix comprises silicon dioxide (SiO₂).

16. The electron source of claim 12, wherein said matrix is operable to provide heat dissipation for said plurality of aligned carbon nanotubes.

17. The electron source of claim 12, wherein said matrix comprises a conductive dopant.

18. The electron source of claim 17, wherein at least one of said plurality of aligned carbon nanotubes is physically separate from said electrode, and wherein said conductive dopant provides conductivity between said electrode and said at least one carbon nanotubes not in physical contact with said electrode.

19. The electron source of claim 12, wherein each of said plurality of aligned carbon nanotubes is substantially equidistant from adjacent carbon nanotubes.

20. A method of providing field emission current using an electron source, said method comprising:
applying an electric field to said electron source, wherein said electron source comprises:
a substrate comprising an electrode;
a plurality of aligned carbon nanotubes, wherein said plurality of aligned carbon nanotubes are distinct from said electrode, and wherein said plurality of aligned carbon nanotubes are operable to emit electrons in response to a field applied to said electrode; and
a matrix disposed between said plurality of aligned carbon nanotubes for securing said plurality of aligned carbon nanotubes with respect to one another and with respect to said substrate; and
emitting electrons from said plurality of aligned carbon nanotubes to provide said field emission current, wherein at least one of said plurality of aligned carbon nanotubes is in physical contact with said electrode.

21. The method of claim 20, wherein said plurality of aligned carbon nanotubes are aligned substantially perpendicular with respect to said substrate.

22. The method of claim 20, wherein said matrix comprises a cross-linked thermoset polymer.

23. The method of claim 20, wherein said matrix comprises silicon dioxide (SiO₂).

24. The method of claim 20, wherein said matrix is operable to provide heat dissipation for said plurality of aligned carbon nanotubes.

25. The method of claim 20, wherein said matrix comprises a conductive dopant.

26. The method of claim 25, wherein at least one of said plurality of aligned carbon nanotubes is physically separate from said electrode, and wherein said conductive dopant provides conductivity between said electrode and said at least one carbon nanotubes not in physical contact with said electrode.

27. The method of claim 20, wherein each of said plurality of aligned carbon nanotubes is substantially equidistant from adjacent carbon nanotubes, and wherein a current density across said plurality of aligned carbon nanotubes is substantially uniform.

28. The method of claim 20 further comprising:
using said field emission current to perform at least one of image display, electron microscopy, field emission lighting, x-ray source, space propulsion, traveling wave tube amplifiers, air remediation, water remediation and cold field emission.
